(19) United States
(12) Patent Application Publication
(10) Pub. No.: US 2013/0214467 A1
(43) Pub. Date: Aug. 22, 2013

(54) CLAMPING FIXTURE FOR CLAMPING A WORKPIECE

(71) Applicants: Stefan Heyn, Engelsbrand (DE); Jean-Claude Montandon, Arch (CH)

(72) Inventors: Stefan Heyn, Engelsbrand (DE); Jean-Claude Montandon, Arch (CH)

(73) Assignees: Prazisionsmechanik Heyn GmbH, Pforzheim (DE); Jean-Claude Montandon, Arch (CH)

(21) Appl. No.: 13/809,042

(22) PCT Filed: Jul. 13, 2011
(86) PCT No.: PCT/EP2011/003500

§ 371 Date: Mar. 22, 2013

(30) Foreign Application Priority Data
Jul. 14, 2010 (DE) 10 2010 027 157.7

(51) Int. Cl. B25B 5/14; B25B 11/00

(52) U.S. Cl. CPC B25B 5/14; B25B 11/00
USPC 269/48.1; 269/216

(57) ABSTRACT

In a clamping fixture (1) for clamping a workpiece (10), wherein the clamping fixture has at least one clamping device (4) and at least one guiding device working together with the clamping device, wherein the clamping device can be moved axially along the guiding device, wherein the clamping device has a radial profiling (6), wherein the guiding device has an opposing profiling (7), corresponding to the radial profiling of the clamping device, and wherein, when there is an axial movement of the profiling of the clamping device along the opposing profiling of the guiding device, the clamping device is forced in a substantially radial direction, and thereby clamps the workpiece in place, less susceptibility to wear, and consequently a longer operational service life, is obtained by the clamping device being formed in at least two parts.

The present invention relates to a clamping fixture for clamping a workpiece, wherein the clamping fixture has at least one clamping device and at least one guiding device which cooperates with the clamping device, wherein the clamping device is displaceable axially along the guiding device, wherein the clamping device has a radial profiling, wherein the guiding device has a counter profiling which corresponds to the radial profiling of the clamping device, and wherein in the case of an axial displacement of the profiling of the clamping device along the counter profiling of the guiding device, the clamping device is pressed in the substantially radial direction and as a result the workpiece is clamped.

These types of clamping fixtures or clamping tools have been known for a long time in the prior art. An exemplary field of application for such a clamping fixture is in the holding of workpieces during machining. The machining, in this case, can be a grinding process, for example external cylindrical grinding. Obviously, other types of machining can also be possible, such as, for example, turning or milling, with or without a finishing process, such as, for example, honing, grinding, lapping and the like. When clamping workpieces, the difference is made quite generally between internal clamping and external clamping. In the case of internal clamping, the workpiece is held inside the same in a recess thereof and the clamping is generated by a force which acts radially outward. In the case of external clamping, the workpiece is held on the outer circumference thereof and the clamping action is generated by a force which acts radially inward.

It is disadvantageous in the case of the known clamping fixtures that the clamping device, which, for example, has an expanding crown carrier, is a wearing part which has to be replaced frequently, the production process then being interrupted. In principle, wearing of the clamping device can certainly be minimized by selecting the material in a suitable manner, however this is not simple in the case of the clamping tool as claimed in the prior art. On the one hand, the material has to be hard and sturdy, it also having to have a certain elasticity, however, on account of the expanding clamping function. In this case, the elasticity of the clamping device is necessary in order to enable clamping and automatic releasing. Said material demands are opposing such that, with reference to the material of the clamping device, in practice a compromise always has to be found between wear resistance and elasticity. The clamping device, as a rule, is also relatively long as the desired elasticity with simultaneous material hardness can only be achieved in this manner

Consequently, the object underlying the invention is to avoid the disadvantages of the prior art and, in particular, to develop a clamping fixture of the aforementioned type further in such a manner that it is less susceptible to wear and consequently has a longer service life.

Said object is achieved in the case of a fixture of the aforementioned type in that the clamping device is realized in at least two parts.

One advantage of the present invention is that the structural degrees of freedom are increased through the two-part design of the clamping device. In particular, the part of the clamping device which has the profiling can be produced from a suitable wear-resistant material such that the service life is increased and fewer interruptions caused by replacement operations are necessary in the production process.

In addition, it is preferred that the clamping device has a clamping element which has the profiling of the clamping device, and has a further element which is connected to the clamping element. Said preferred two-part design separates the clamping element from a further element in a structural manner and it can then serve the drive or the holding of the clamping element depending on the kinematic development of the clamping fixture.

In an advantageous manner, the further element is a lifting element for the axial displacement of the clamping element. The lifting element can be produced from a particularly tough material, whilst the material of the clamping element is selected with reference to a high level of wear resistance.

As claimed in a preferred embodiment, the further element is connected to the clamping element by means of a pivoting device, preferably an articulated joint. In a structurally preferred design, the articulated joint is a pin bearing. A lever action is provided between the clamping element and the further element by means of the pivoting device, as a result of which a prestressing of the profiling of the clamping element along the counter profiling is possible in the proper operational clamping state. The pivoting device, in this case, supports both the clamping and the releasing of the workpiece.

In an advantageous manner, the clamping element is connected to the further element by means of a connecting device, wherein the connecting device connects the clamping element and the further element in a substantially axially rigid manner and allows for a radial pivoting of the clamping element. The connecting device is, as previously described, preferably an articulated joint, in particular a pivot joint.

In addition, it is preferred that the clamping element is connected to the further element additionally by means of a prestressing element, wherein the prestressing element prestresses the clamping element and the further element together. The prestressing element is preferably a spring device, preferably a compression spring, which, in particular in the case of an asymmetrically arranged connecting element, provides for a sturdy relative positioning of the clamping element and further element, i.e. in particular the lifting element. The spring device, in this case, also provides for a prestressing of the profiling along the counter profiling.

In addition, it is preferred that the clamping fixture additionally has a prestressing element which, in particular without axial displacement of the profiling of the clamping device along the counter profiling of the guiding device, prestresses the profiling of the clamping device against the counter profiling of the guiding device. The prestressing element, consequently, ensures an operating state of the clamping fixture for loading and unloading a workpiece by providing for a defined abutment of profiling/counter profiling such that in the initial position, with reference to the profiling/counter profiling, no radial pressure is exerted onto a workpiece. Consequently, radial pressure is only generated by the movement of the profiling on the counter profiling. In this case, the prestressing element is preferably a pressure ring. The pressure ring is preferably arranged adjacent the profiling/counter profiling or the end portion of the clamping element in order to ensure optimum lever conditions for long, thin parts.

In an advantageous manner, the clamping element and the further element are produced from different materials. In this case, it is preferred that the material of the clamping element has a high degree of wear resistance. This increases the wear resistance of the clamping device. Unlike the prior art, in the case of the design of the clamping element as claimed in the invention, a compromise with reference to the material selection no longer has to be made, it no longer having to be elastic on account of the two-part structure as claimed in the invention.

As claimed in an advantageous development of the invention, the clamping fixture is provided for internal clamping. In a preferred application, in this case, the at least one clamping element is realized as a clamping mandrel, as a mandrel with clamping lamellas or as an expanding crown carrier.

As claimed in a further advantageous development of the invention, the clamping fixture is provided for external clamping. In a preferred application, in this case, the at least one clamping element is realized as a clamping collet or as a clamping chuck.

Further preferred embodiments of the invention are disclosed in the dependent claims.

The invention, as well as further features, aims, advantages and application possibilities of the same, is or are explained in more detail below by way of a description of preferred exemplary embodiments with reference to the accompanying drawings. In the drawings the same references designate the same or corresponding elements. In this case, all described and/or graphically represented features, on their own or in arbitrary sensible combination, form the object of the present invention, irrespective of their summary in the claims or their dependence. In the drawings:

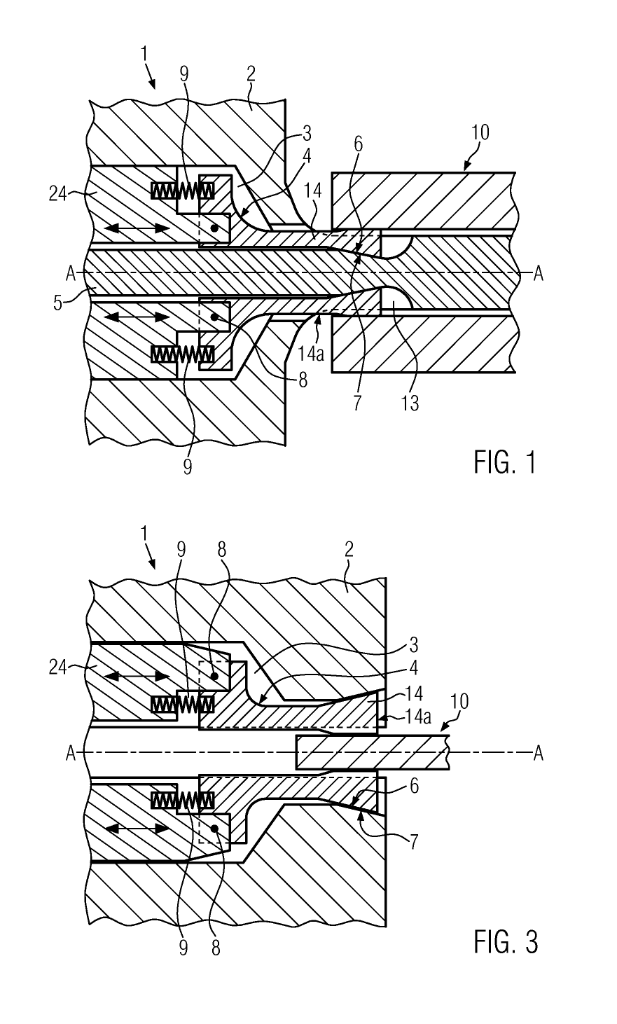

FIG. 1 shows a highly schematic longitudinal sectional representation of a first exemplary embodiment of a clamping fixture as claimed in the present invention for the internal clamping of a workpiece;

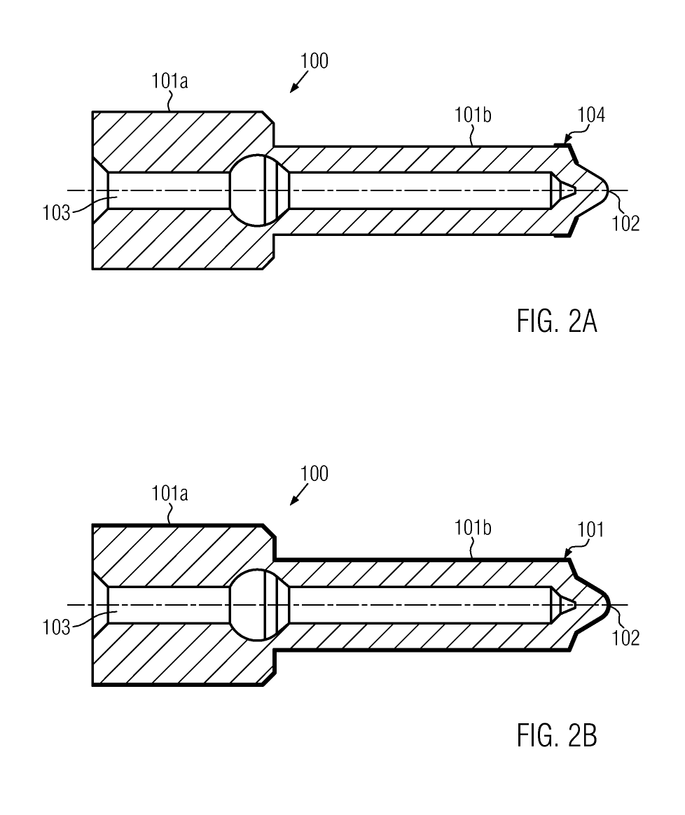

FIG. 2A shows a schematic longitudinal sectional representation of an exemplary workpiece for explaining a first method step for the external machining of the same in conjunction with the clamping fixture as claimed in the invention;

FIG. 2B shows a schematic longitudinal sectional representation of the workpiece of FIG. 1A for explaining a second method step for the external machining of the same in conjunction with the clamping fixture as claimed in the invention;

FIG. 3 shows a highly schematic longitudinal sectional representation of a second exemplary embodiment of a clamping fixture as claimed in the present invention for the external clamping of a workpiece;

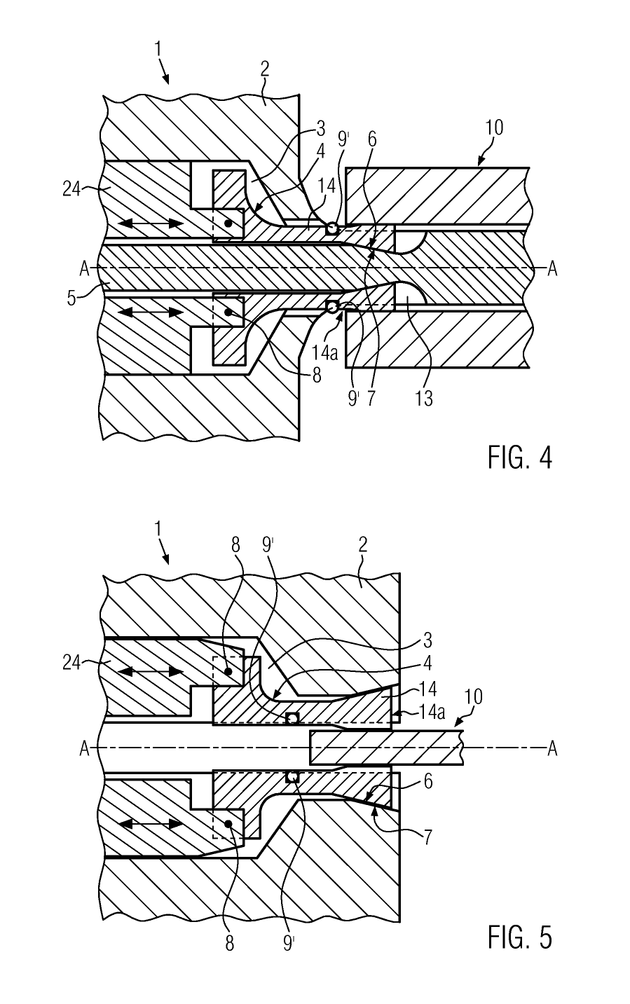

FIG. 4 shows a highly schematic longitudinal sectional representation of a third exemplary embodiment of a clamping fixture as claimed in the present invention for the internal clamping of a workpiece; and

FIG. 5 shows a highly schematic longitudinal sectional representation of a fourth exemplary embodiment of a clamping fixture as claimed in the present invention for the external clamping of a workpiece.

Four preferred exemplary embodiments of the present invention are explained in more detail below by way of the highly schematic representations of FIGS. 1, 3, 4 and 5. FIGS. 2A and 2B serve to explain an application of a clamping fixture as claimed in the invention.

FIG. 1 shows a clamping fixture or clamping tool which is designated in its entirety by the reference 1. The workpiece which is to be clamped by means of the clamping fixture 1 is designated by the reference 10. An exemplary application of a workpiece 10 to be clamped is explained in more detail below with reference to FIGS. 2A and 2B. In FIG. 1, which shows the application of internal clamping in more detail, the workpiece 10 consequently has a central axial recess 13 in which the workpiece 10 is held in the clamped state. A recess 3, in which the clamping device 4 is mounted so as to be axially movable, is provided inside the tool basic body 2. The direction of movement of the clamping device 4 is indicated in FIG. 2 by the double arrow and runs parallel to the central longitudinal axis or axis of symmetry A-A of the clamping fixture 1 or of the workpiece 10. The clamping device 4 is realized as claimed in the invention in two parts and has a clamping element 14 and a lifting element 24. The lifting element 24 is preferably driven by a drive device (not shown) which, for example, can be hydraulic or pneumatic. The clamping element 14 and the lifting element 24 are essentially realized as cylindrical sleeves and are arranged around a holding part 5 of the clamping fixture 1, said holding part preferably being realized as a holding mandrel.

The clamping element 14 has a portion 14a which protrudes out of the tool basic body 2, the thickness of which is widened inward radially toward its end remote from the tool basic body 2. A truncated-cone-shaped material recess, which can be seen in the longitudinal sectional view in FIG. 2 as an inclination, is consequently realized on the radially inner side at the end, remote from the clamping fixture, of the portion 14a of the clamping element 14, as a result of which a profiling 6 is provided. The profiling 6 abuts against a counter profiling 7 of the holding part 5 of the clamping fixture 1 which cooperates with said profiling. The counter profiling 7 is realized as a truncated cone which corresponds to the truncated-cone-shaped material recess of the section 14a, the outer dimensions of said truncated cone being somewhat smaller than the inner dimensions of the profiling 6. The profiling 6, in said exemplary embodiment, is arranged radially outside of the counter profiling 7. It should be noted that the profiling 6 or the counter profiling 7 quite generally can be in the most varied forms which enable clamping or releasing; they are consequently not restricted to the truncated-cone shape represented and described. In a preferred embodiment (not shown) of the invention, the form of the profiling 6 or of the counter profiling 7 corresponds to an application-specific ramp. A quite special clamping sequence can be realized by means of the application-specific shaping. For example, this means that during the clamping operation, it is possible to realize a prestressing process first of all, then a stopping process at a fixed stop and finally a finish clamping process.

The lifting element 24, which is connected to the clamping element 14 by means of a connecting device in the form of an articulated joint 8, is provided for the axial movement of the clamping element 14. In the exemplary embodiment, the articulated joint 8 is a pin joint. The articulated joint 8 provides for an essentially axially fixed connection between the lifting element 24 and the clamping element 14, but allows a rotatability of the clamping element 14 in the radial direction, i.e. for the clamping operation. In order to hold the lifting element 24 and the clamping element 14 together in a prestressed manner, a prestressing element in the form of a spring device 9 is provided between the lifting element 24 and the clamping element 14. The spring device 9 is provided radially outside of the articulated joint 8. In the case of the present invention, consequently, the clamping element 14 is separated from the lifting or drive element 24 and is connected to same in a prestressed and articulated manner The spring device 9 provides for a prestressing of the clamping element 14 and, more precisely, of the portion thereof which has the profiling 6 against the portion of the holding part 5 or of the tool basic body 2 having the counter profiling 7. Unlike the prior art, consequently, the clamping or releasing function is no longer generated by the elasticity of the material of the clamping element 14, but by the prestressing force of the spring device 9 which is realized as a compression spring. Consequently, the disadvantage of the prior art is overcome, namely the necessary material selection for the clamping element 14, which impairs the wear resistance of the clamping element 14. The principal purpose of the compression spring 9, which acts on the clamping element 14 by means of the articulated joint 8, is in holding the profiling 6 in a prestressed manner on the counter profiling 7 when the workpiece 10 is not mounted such that the workpiece 10 is easily able to be placed in position or ejected.

The particular advantage of said two-part design of the clamping device 4 is that optimum materials are able to be used in each case for the clamping element 14 and the lifting element 24, which increases the service life of the clamping element 14 (or also of the lifting element 24) in relation to wear and tear in an extreme manner. With the present invention, the material of the clamping element 14 can be selected with regard to a high level of wear resistance and no longer has to be elastic. The entire arrangement is also more compact as the overall length of the clamping device 4 can be considerably shorter.

FIG. 1 shows the state of the non-clamped workpiece 10, i.e. the workpiece 10 is simply placed onto the end portion 14a of the clamping element 14. For clamping the workpiece 10, the clamping element 14 is then moved into the tool basic body 2, i.e. displaced to the left according to the representation in FIG. 1, such that the profiling 6 is displaced to the left along the counter profiling 7. As a result of the predetermined forced abutment or positive locking of the profiling 6 and of the counter profiling 7, the end portion 14a is curved or pressed outward and consequently the workpiece 10 is fixedly clamped. A sleeve-shaped end portion 14a (in the case of an axially symmetrical design) is provided according to the representation in the drawing. However, several end portions 14a, in particular realized in a crown-like manner, can be arranged circumferentially around the holding part 5 in order to form an expanding crown carrier.

An exemplary application of a clamping fixture as claimed in the present invention is explained in more detail below with reference to FIGS. 2A and 2B. FIGS. 2A and 2B show a schematic representation of an exemplary workpiece in the form of a rotationally symmetrical body 100.

The grinding process of the outer contour 101 (cf. FIG. 2B) of the body 100 is explained in more detail by way of FIGS. 2A and 2B. In this case, this is the finish grinding of the outer contour 101 of the body 100, two operations or method steps being provided in an advantageous manner in one clamping process. In this case, the grinding task consists in that the complete outer contour 101 of the body 100 has to be ground in a highly precise, time-saving and efficient manner. The outer contour 101 has a first short, wide portion 101a on the end of the body 100 remote from the end 102. In addition, the outer contour 101 has a second long, narrower portion 101b which connects to the portion 101a in the direction toward the end 102. The two sections 101a and 101b which are stepped in their cross-sectional dimensions are cylindrical portions of the body 100 and extend in the direction toward the end 102, i.e. in the representation in the drawing from left to right. Opposite the end 102, the body 100 has a central longitudinal recess 103 in the form of a blind hole bore which extends parallel to the longitudinal axis of the body 100.

In order then to finish grinding the outer contour 101 of the body 100, the body 100, and more precisely the recess 103 thereof, is placed onto a central mandrel (not shown) and is mounted there so as to be rotatable. The body is then driven on the centering mandrel at the portion 101a of the outer contour 101 by means of an internal ring drive (not shown). The body 100, in this case, is pressed by the inclined position of the drive ring against the centering of the inner bore. In said first method step, a centering bevel 104 (cf. FIG. 1A) is ground in an unsupported manner by means of a grinding disk (not shown). The centering bevel 104 is a highly precisely ground edge on the end of the second portion 101b which points to the end 102. It should be noted for clarification that there is obviously still no centering bevel on the unfinished body of the body 100. The purpose of the centering bevel 104 is for preparing for the subsequent machining of the entire outer contour 101 in order to make it as precise as possible.

After said first method step in which the centering bevel 104 is ground (cf. FIG. 2A), the complete external cylindrical grinding of the body 100 then takes place (cf. FIG. 2B). To this end, the inner ring drive unit is pushed back into the rest position and the body 100 is positioned at the grinding disk in a highly precise manner at the previously ground centering bevel 104. The body 100 is internally clamped at the internal diameter by means of an expanding crown carrier which is realized on the centering mandrel. The complete outer contour 101 is then ground in a size-controlled manner in one pass, the body 100 being held at the end 102 thereof in a tailstock (not shown) such that the grinding is no longer carried out in an unsupported manner as in the case of the first method step, but the body 100 is fixedly clamped.

In the case of the above-explained grinding process, the body 100 is consequently mounted rotatably on the centering mandrel in a first method step (for grinding the centering bevel) and in the second method step for finish grinding, the entire outer contour 101 is non-rotatably clamped on the centering mandrel by means of an expanding crown clamping process. The entire machining time for both operations or method steps, in this case, is between 15 and 25 seconds.

The first exemplary embodiment of the present invention, described above in conjunction with FIG. 1, is suitable to be used for machining the outer contour of the body 100 (cf. FIGS. 2A and 2B). The first operation for producing the centering bevel 104 is carried out with the clamping element 14 released and the second operation is carried with the clamping element 14 clamped, i.e. the portion 14a of the clamping element 14 is moved into the tool basic body 2 in order to clamp the workpiece 10, i.e. the body 100, on the inside.

It must be noted quite fundamentally that the clamping of the workpiece 10 comes about by a relative movement of the profiling 6 on the counter profiling 7. Consequently, the workpiece 10 can be clamped by a movement of the lifting element 24 into the tool basic body 2 (i.e. to the left in the representation in FIG. 2), however the workpiece 10 can also be clamped by a movement of the counter profile 7 out of the tool basic body 2 (i.e. to the right in the representation in FIG. 2). Thus, in the latter case, the lifting element 24 and the clamping element 14 are stationary and are not moved axially.

FIG. 3 shows a second exemplary embodiment of the present invention which serves for external clamping and, for example, can be also be used as a clamping collet or a clamping chuck. The second exemplary embodiment of the present invention shown in FIG. 3 is generally similar to the first exemplary embodiment already described above in conjunction with FIG. 1 such that, in order to avoid repetitions, just the differences to the first exemplary embodiments are described in more detail below. The clamping element 14, which together with the lifting device 24 forms the clamping device 4, has a radially outwardly increasing widening in the direction away from the tool basic body 2 in order to form a truncated-cone-shaped profiling 6.

The profiling 6 abuts against a corresponding counter profiling 7. Contrary to the first exemplary embodiment according to FIG. 2, in the present case the profiling 6 is a truncated cone and the counter profiling 7 is a truncated-cone-shaped recess. The counter profiling 7 is arranged radially outside of the profiling 6. The internal diameter of the counter profiling 7 is somewhat greater than the outer diameter of the profiling 6. As already described, a movement of the lifting element 24 into the tool basic body 2, i.e. to the left according to the representation in FIG. 3, provides for a movement of the clamping element 14 into the tool 1, as a result of which the profiling 6 slides along on the counter profiling 7 and the outer end portion 14a of the clamping element 14 clamps the workpiece 10 in the manner of a clamping jaw. A movement of the lifting element 24 out of the tool body, i.e. to the right according to the representation in FIG. 3, then provides for a releasing of the portion 14a, by means of the spring action of the spring element 9, and the workpiece 10 is released.

FIGS. 4 and 5 show a schematic representation of a third or fourth exemplary embodiment of the present invention. The third exemplary embodiment (FIG. 4) corresponds in general to the first exemplary embodiment described above in conjunction with FIG. 1 and is provided for internal clamping. The fourth exemplary embodiment (FIG. 5) corresponds in general to the second exemplary embodiment already described above in conjunction with FIG. 3 and is provided for external clamping. Consequently, only the differences to the already described exemplary embodiments are explained below in order to avoid repetitions. The difference between the third and fourth exemplary embodiments and the first or second exemplary embodiment is in the design of the prestressing element 9′. In the case of the first two exemplary embodiments, the prestressing element 9 is a compression spring which provides for an abutment or prestressing of the profiling 6 and counter profiling 7 even when the workpiece 10 is not present. The prestressing element 9′ certainly has the identical function as the prestressing element 9, however, according to the third and fourth exemplary embodiments is realized as a pressure ring, in particular as an O-ring. The prestressing element 9′ is not arranged between the lifting element 24 and the clamping element 14 and does not connect said two parts. Instead of this, the prestressing element 9′ in the third exemplary embodiment (FIG. 4) is arranged directly outside around the clamping element 14 offset axially inwardly (into the tool basic body) with respect to the outer end portion 14a. The pressure ring 9′ is inserted in a ring-shaped groove and, by way of its prestressing, presses the profiling 6 inward onto the counter profiling 7. In a corresponding manner, in the case of the fourth exemplary embodiment (FIG. 5), the pressure ring is arranged inside around the clamping element 14 offset axially inwardly (into the tool basic body) with respect to the outer end portion 14a and, by means of its prestressing, presses outward (in the opposite direction to the third exemplary embodiment) such that once again the profiling is pressed or prestressed against the counter profiling 7. The third and fourth exemplary embodiments are advantageous in particular in the case of workpieces 10 which are long, thin parts as the pressure rings act in a purely radial manner and the lift conditions are better than in the structural development using compression springs (cf. FIGS. 1 and 3).

The invention has been explained in more detail above by way of preferred embodiments of the same. However, it is obvious to an expert that different conversions and modifications can be made without deviating from the concepts underlying the invention.

### LIST OF REFERENCES

1 Clamping fixture or clamping tool

2 Tool basic body

3 Recess

4 Clamping device

5 Holding part

6 Profiling

7 Counter profiling

8 Connecting device or articulated joint

9, 9′ Prestressing element or spring device

10 Workpiece

13 Recess

14 Clamping element

14a End portion

24 Lifting element

100 Body

101 Outer contour

101a First portion

101b Second portion

102 End of the body

103 Longitudinal recess

104 Centering bevel

1. A clamping fixture (1) for clamping a workpiece (10), wherein the clamping fixture (1) has at least one clamping device (4) and at least one guiding device which cooperates with the clamping device, wherein the clamping device (4) is displaceable axially along the guiding device, wherein the clamping device (4) has a radial profiling (6), wherein the guiding device has a counter profiling (7) which corresponds to the radial profiling of the clamping device, and wherein in the case of an axial displacement of the profiling (6) of the clamping device (4) along the counter profiling (7) of the guiding device, the clamping device (4) is pressed in the substantially radial direction and as a result the workpiece (10) is clamped, characterized in that the clamping device is realized in at least two parts.

2. The clamping fixture (1) as claimed in claim 1, characterized in that the clamping device (4) has a clamping element (14) which has the profiling (6) of the clamping device (4), and a further element which is connected to the clamping element (14).

3. The clamping fixture (1) as claimed in claim 2, characterized in that the further element is a lifting element (24) for the axial displacement of the clamping element.

4. The clamping fixture as claimed in claim 2, characterized in that the further element is connected to the clamping element by means of a pivoting device.

5. The clamping fixture (1) as claimed in claim 4, characterized in that the pivoting device is an articulated joint (8), and preferably a pin bearing.

6. The clamping fixture (1) as claimed in claim 2, characterized in that the clamping element (14) is connected to the further element by means of a connecting device, wherein the connecting device connects the clamping element (14) and the further element in a substantially axially rigid manner and allows for a radial pivoting of the clamping element (14).

7. The clamping fixture (1) as claimed in claim 6, characterized in that the clamping element (24) is connected to the further element additionally by means of a prestressing element, wherein the prestressing element prestresses the clamping element and the further element.

8. The clamping fixture (1) as claimed in claim 7, characterized in that the prestressing element is a spring device (9).

9. The clamping fixture (1) as claimed in claim 1, characterized in that the clamping fixture (1) additionally has a prestressing element which prestresses the profiling (6) of the clamping device (4) against the counter profiling (7) of the guiding device.

10. The clamping fixture (1) as claimed in claim 9, characterized in that the connecting device and the prestressing element are arranged offset radially and/or axially with respect to each other.

11. The clamping fixture (1) as claimed in claim 9, characterized in that the prestressing element is realized as a pressure ring.

12. The clamping fixture (1) as claimed in claim 2, characterized in that the clamping element (14) and the further element are produced from different materials.

13. The clamping fixture (1) as claimed in claim 12, characterized in that the material of the clamping element (14) has a high degree of wear resistance.

14. The clamping fixture (1) as claimed in claim 13, characterized in that the material of the clamping element (14) is hardened tool steel, hardened powder steel or hard metal.

15. The clamping fixture (1) as claimed in claim 1, characterized in that the clamping fixture (1) is provided for internal clamping.

16. The clamping fixture (1) as claimed in claim 2, characterized in that the at least one clamping element (14) is realized as a clamping mandrel, as a mandrel with clamping lamellas or as an expanding crown carrier.

17. The clamping fixture (1) as claimed in claim 2, characterized in that the clamping fixture (1) is provided for external clamping.

18. The clamping fixture (1) as claimed in claim 17, characterized in that the at least one clamping element (14) is realized as a clamping collet or as a clamping chuck.

19. The clamping fixture (1) as claimed in claim 1, characterized in that the forming of the profiling (6) and of the counter profiling (7) is in such a manner that an application-specific clamping sequence having at least two clamping states is provided.

20. The clamping fixture (1) as claimed in claim 19, characterized in that the at least two clamping states have at least one lighter and one more solid clamping process.
